(19) United States
(12) Patent Application Publication
(10) Pub. No.: US 2014/0341839 A1
(43) Pub. Date: Nov. 20, 2014

(54) BIOCIDAL COATING

(71) Applicants: Steven Kritzler, Cronulla (AU); Michael Kritzler, Caringbah North (AU)

(72) Inventors: Steven Kritzler, Cronulla (AU); Michael Kritzler, Caringbah North (AU)

(73) Assignee: NOVAPHARM RESEARCH (AUSTRALIA) PTY LTD, Rosebery, NSW (AU)

(21) Appl. No.: 14/344,686

(22) PCT Filed: Sep. 13, 2012
(86) PCT No.: PCT/AU2012/001093

§ 371 Date: Aug. 8, 2014

(30) Foreign Application Priority Data
Sep. 13, 2011 (AU) 2011903763

(51) Int. Cl. A01N 25/24; C09D 5/14; A01N 33/12

(52) U.S. Cl. CPC A01N 25/24; A01N 33/12; C09D 5/14
USPC 424/78.19; 524/549; 427/331

(57) ABSTRACT

The invention relates to a biocidal composition comprising a carboxyl functional polymer and biocidal quaternary ammonium ions. The polymer is a copolymer comprising maleic acid monomer units and/or anions thereof and vinyl ether comonomer units. The composition may be in the form of a film on a surface or in the form of a solution.

### PRIORITY

The present application claims priority from Australian provisional patent application number AU2011903763, the entire contents of which are incorporated herein by cross-reference.

### TECHNICAL FIELD

The present invention relates to biocidal coatings and processes for making them.

### BACKGROUND OF THE INVENTION

Air conditioning condensers, for example those used in automobiles, are typically manufactured with closely placed aluminium heat exchange fins for effective heat transfer with air. Moisture from the cooling air passing across the surface of the fins condenses on the surface, and in use there are usually droplets of water residing on or flowing across the condenser surface. Such conditions are ideal for growth of biofilm and other microbial colonisation on the surface and it is common for an increasing coating of biofilm on the surface of the fins to compromise airflow contact with the surface as well as its heat transfer efficiency, resulting in loss of effectiveness and eventually potentially rendering the unit inoperable.

The inventor's prior patent applications entitled “Biofilm growth prevention” (AU2004241665) and “Biostatic polymer” (AU2006209795) described coatings which resists biofilm growth for long periods on wet surfaces. However, neither of those compositions was suitable for application to automotive air-conditioner condensers and similar applications for the following reasons:
the compositions were based on Triclosan which is out of favour because of its lack of biodegradability;
the compositions did not exhibit sufficient biocidal longevity for the application;
the compositions are colourless and consequently require the addition of pigments so that the film coverage and integrity can be readily and visually inspected. The addition of pigments greatly adds to the cost of compositions because pigments commonly have to be very finely ground (usually by ball milling with cooling). The size reduction operation is both time and energy intensive, and hence costly. The ground pigments then require dispersion in the composition, which is also an expensive operation and which adds further to the cost. Also this addition adds significantly to the thickness of the coating thus detrimentally affecting heat exchange efficacy.

It would be highly desirable to have an inexpensive biocidal coating. Such a coating would preferably provide good unprimed adhesion to clean unprepared metallic surfaces such as steels and aluminium. It would be preferable that such a coating was substantive on an unprimed aluminium surface. It would also preferable that it be durable. It would further be preferable if the coating remained biocidally effective to prevent biofilm growth on the treated surface for an extended period, preferably a period of many years. An additional desirable property is that it be inherently coloured so as to be readily visible when coated on a surface of different colour. It would be a further advantage if the colour was formed upon the effective curing of the coating, thereby serving the dual purpose of to providing a visible coating and additionally an indication that the required curing cycle had been completed.

### OBJECT OF THE INVENTION

It is an object of the invention to provide a composition which overcomes or at least ameliorates the disadvantages of prior art. It is a further object to at least partially satisfy the above need.

### SUMMARY OF THE INVENTION

In a first aspect of the invention there is provided a biocidal composition comprising a carboxyl functional polymer and biocidal quaternary ammonium ions or salts.

The following aspects may be used in conjunction with the first aspect, either individually or in any suitable combination.

The polymer may comprise maleic acid monomer units and/or anions thereof. It may comprise a plurality of vicinal dicarboxylic acid (or mono- or di-anion thereof) pairs. It may be a copolymer. It may comprise vinyl ether comonomer units. It may be prepared from a maleic anhydride-co-alkyl vinyl ether copolymer. It may for example be a maleic acid-co-alkyl vinyl ether copolymer or a maleate-co-alkyl vinyl ether copolymer. In some embodiments the polymer may be a poly(meth)acrylic acid homopolymer or copolymer. The polymer may be a maleic acid copolymer or a maleic anhydride copolymer. It may be a maleic acid-co-alkene copolymer or a maleic anhydride-co-alkene copolymer.

The biocidal quaternary ammonium ions may be alkyl benzyl dimethylammonium ions or dialkyl dimethylammonium ions or other biocidal quaternary ammonium ions or may be a mixture of any two or more of these.

The composition may have no organic solvents therein. This should be taken to indicate that no significant quantities of organic solvents are present, e.g. less than about 100 ppm, or less than about 10, 1 or 0.1 ppm (on a w/v basis).

In some embodiments the biocidal composition is a solution, e.g. an aqueous solution, comprising said polymer and quaternary ammonium ions. The molecular weight and concentration of the polymer may be such that the composition is sprayable. The composition may be of sufficiently low viscosity as to be capable of being applied to a surface by spraying with normal pressurised air or airless spraying equipment or by dipping and allowing to drain by gravity. The molecular weight and concentration of the polymer may be such that the composition is of sufficiently low viscosity as to be capable of being applied to a surface by spraying with normal pressurised air or airless spraying equipment or by dipping and allowing to drain by gravity.

In other embodiments the biocidal composition is in the form of a film on a surface. The biocidal composition may comprise less than about 10% by weight of water. The film may be from about 1 to about 100 microns thick. In certain embodiments the film is crosslinked.

In one embodiment there is provided a biocidal composition comprising a maleic acid-co-alkyl vinyl ether copolymer or a maleate-co-alkyl vinyl ether copolymer and alkyl benzyl dimethylammonium ions or dialkyl dimethylammonium ions (or other biocidal quaternary ammonium ions).

In another embodiment there is provided an aqueous solution comprising a maleic acid-co-alkyl vinyl ether copolymer or a maleate-co-alkyl vinyl ether copolymer and alkyl benzyl dimethylammonium ions or dialkyl dimethylammonium ions (or other biocidal quaternary ammonium ions) wherein the molecular weight and concentration of the polymer is such that the composition is sprayable, for example sprayable onto a surface by normal spraying equipment or by dipping and allowing to drain by gravity.

In another embodiment there is provided a biocidal composition in the form of a film on a surface, said composition comprising a maleic acid-co-alkyl vinyl ether copolymer or a maleate-co-alkyl vinyl ether copolymer and alkyl benzyl dimethylammonium ions or dialkyl dimethylammonium ions (or other biocidal quaternary ammonium ions) and having less than about 10% by weight of water. The film may be capable of developing colour on heating. It may be capable of curing on heating. It may be tack free. It may be capable of developing different colours at different stages of cure, i.e. at different times and/or temperatures of heating. It may be capable of developing the colour in the absence of added pigment or colouring agent. It may be cured. It may be crosslinked. It may be coloured and have no pigment or colouring agent.

In a second aspect of the invention there is provided a process for making a biocidal composition, said process comprising combining a polymer, a biocidal quaternary ammonium salt and an liquid so as to form a solution, said polymer comprising one or more of carboxylic acid groups, carboxylate groups and anhydride groups. The composition of the first aspect may be the solution so formed. The process of this aspect may be a process for making the composition of the first aspect.

The following options may be used in conjunction with the second aspect, either individually or in any suitable combination.

The carboxylic acid groups may be present as maleic acid monomer units and/or as acrylic acid monomer units and/or as methacrylic acid monomer units. The carboxylate groups may be present as maleate monomer units and/or as acrylate monomer units and/or as methacrylate monomer units. The anydride groups may be present as maleic anhydride monomer units. The carboxylic acid groups, or some of the carboxylic acid groups, may be present as vicinal pairs. If the polymer comprises maleic anhydride monomer units, the process may comprise hydrolysing the maleic anhydride monomer units to provide malic acid monomer units (or mono- or di-anions thereof).

The quaternary ammonium salt may be used at about 5 to about 10% by weight of the polymer. It may be used in the range of about 10% to about 100% of the weight of the polymer.

The polymer may be a copolymer. It may comprise vinyl ether comonomer units. It may be, for example, a maleic anhydride-co-alkyl vinyl ether copolymer or a maleic acid-co-alkyl vinyl ether copolymer or a maleate-co-alkyl vinyl ether copolymer or a mixture of any two or more of these. It may be a maleic acid-co-alkene copolymer or a maleic anhydride-co-alkene copolymer.

The biocidal quaternary ammonium salt may be an alkyl benzyl dimethylammonium salt or a dialkyl dimethylammonium salt or other biocidal quaternary ammonium salt or a mixture of any two or more of these.

The molecular weight of the polymer and the ratio of the polymer to the aqueous liquid may be such that the composition is sprayable. They may be such that the viscosity of the composition is sufficiently low that the composition is sprayable by normal spraying equipment.

The process may additionally comprise the step of applying the composition to a surface and allowing the composition to at least partially dry so as to form a film of the composition on said surface. The at least partial drying may be to a tack free film. It may be to a water content that is sufficiently low that the film is tack free. The composition of the first aspect may be the film so formed.

In an embodiment there is provided a process for making a biocidal composition, said process comprising combining a polymer, an alkyl benzyl dimethylammonium salt or a dialkyl dimethylammonium salt (or other biocidal quaternary ammonium salt) and an aqueous liquid so as to form a solution, said polymer being a maleic anhydride-co-alkyl vinyl ether copolymer or a maleic acid-co-alkyl vinyl ether copolymer or a maleate-co-alkyl vinyl ether copolymer or other quaternary ammonium biocide ions or a mixture of any two or more of these.

In another embodiment there is provided a process for making a biocidal composition, said process comprising:
combining a polymer, an alkyl benzyl dimethylammonium salt or a dialkyl dimethylammonium salt (or other biocidal quaternary ammonium salt) and an aqueous liquid so as to form a solution, said polymer being a maleic anhydride-co-alkyl vinyl ether copolymer or a maleic acid-co-alkyl vinyl ether copolymer or a maleate-co-alkyl vinyl ether copolymer or a mixture of any two or more of these; and
applying the composition to a surface and allowing the composition to at least partially dry, so as to form a film of the composition on said surface. The drying may be to less than 10% w/w solvent (e.g. water) or to greater than 90% w/w solids or to a tack free film.

In a third aspect of the invention there is provided a composition according to the first aspect in the form of a film on a surface, said composition being substantially insoluble in water or being slow to dissolve in water. Thus in this aspect there is provided a biocidal composition comprising a carboxyl functional polymer (e.g. a polymer containing vicinal dicarboxylic groups) and biocidal quaternary ammonium ions, said composition being in the form of a film on a surface and said composition being substantially insoluble in water or slow to dissolve in water. The composition may be a biocidal surface coating.

The following options may be used in conjunction with the third aspect, either individually or in any suitable combination.

The composition may comprise crosslinking units derived from a crosslinker or from more than one crosslinker. Each crosslinker may, independently, be monomeric or may be oligomeric or may be polymeric. Each crosslinker may comprise at least two (optionally two, three, four or five, or more than 5) functional groups, each being capable of reacting with a carboxylate or carboxylic acid group. Each crosslinker may comprise at least two functional groups, each being independently selected from the group consisting of epoxy, hydroxyl, thiol and amine. A suitable crosslinker may comprise at least two hydroxyl groups, or at least two epoxide groups. It may be for example 1,4-butanediol, ethylene glycol or a mixture of these. Alternatively or additionally it may be an epoxy resin or a bisepoxide. Mixtures of suitable crosslinkers, as described above, may be used.

The composition may have no added pigment and may be coloured.

The composition may have a Shore D hardness of at least about 80.

The composition may be hydrophilic. It may have a contact angle with water of less than about 90°, or less than about 60° or 30°.

The composition may have good unprimed adhesion to one or more, optionally all, of aluminium, steels, glass and/or to other suitable substrates.

In an embodiment there is provided a composition, or biocidal surface coating, comprising:
a maleic acid-co-alkyl vinyl ether copolymer or a maleate-co-alkyl vinyl ether copolymer and
alkyl benzyl dimethylammonium ions and/or dialkyl dimethylammonium ions (or other biocidal quaternary ammonium ions),
   said composition being in the form of a film on a surface and said composition being substantially insoluble in water or being slow to dissolve in water.

In another embodiment there is provided a composition, or biocidal surface coating, comprising:
a maleic acid-co-alkyl vinyl ether copolymer or a maleate-co-alkyl vinyl ether copolymer;
crosslinking units derived from a crosslinker comprising at least two functional groups, each being independently selected from the group consisting of hydroxyl, thiol and amine; and
alkyl benzyl dimethylammonium ions and/or dialkyl dimethylammonium ions (or other biocidal quaternary ammonium ions);
   said composition, or biocidal surface coating, being in the form of a film on a surface and said composition, or biocidal surface coating, being substantially insoluble in water or being slow to dissolve in water.

In another embodiment there is provided a composition, or biocidal surface coating, comprising:
a maleic acid-co-alkyl vinyl ether copolymer or a maleate-co-alkyl vinyl ether copolymer;
crosslinking units derived from a crosslinker comprising at least two functional groups, each being independently selected from the group consisting of hydroxyl, thiol and amine; and
alkyl benzyl dimethylammonium ions and/or dialkyl dimethylammonium ions (or other biocidal quaternary ammonium ions), said composition, or biocidal surface coating, being in the form of a film on a surface and said composition, or biocidal surface coating, being substantially insoluble in water or being slow to dissolve in water and having a water contact angle of less than about 90° wherein the composition or biocidal surface coating has no added pigment but is coloured.

In another embodiment there is provided a composition, or biocidal surface coating, comprising:
a maleic acid-co-alkyl vinyl ether copolymer or a maleate-co-alkyl vinyl ether copolymer and
alkyl benzyl dimethylammonium ions and/or dialkyl dimethylammonium ions (or other biocidal quaternary ammonium ions),
   said composition, or biocidal surface coating, being in the form of a film on a surface and said composition, or biocidal surface coating, being substantially insoluble in water or being slow to dissolve in water and said composition, or biocidal surface coating, having no added pigment and being coloured.

In another embodiment there is provided a composition, or biocidal surface coating, comprising:
a maleic acid-co-alkyl vinyl ether copolymer or a maleate-co-alkyl vinyl ether copolymer;
crosslinking units derived from a crosslinker comprising at least two epoxy groups; and
alkyl benzyl dimethylammonium ions and/or dialkyl dimethylammonium ions (or other biocidal quaternary ammonium ions),
   said composition, or biocidal surface coating, being in the form of a film on a surface and said composition, or biocidal surface coating, being substantially insoluble in water or being slow to dissolve in water and having a water contact angle of less than about 90° wherein the composition or biocidal surface coating has no added pigment but is coloured.

Similar films to those of the third aspect may be prepared without quaternary ammonium ions. These are described below (fourteenth aspect). These films may have no biocidal properties. They may have no colour.

In a fourth aspect of the invention there is provided a process for making a composition, or biocidal surface coating, according to the third aspect, said process comprising preparing a composition according to the first aspect in the form of a film on a surface and heating said composition at a sufficient temperature so as to form the is substantially water insoluble composition, or biocidal surface coating. Thus the process comprises:
preparing a biocidal composition which is a solution, e.g. an aqueous solution, comprising a carboxyl functional polymer and biocidal quaternary ammonium ions or salts,
applying the composition to a surface;
allowing the composition to at least partially dry to form a film, commonly a tack free film; and
heating said film at a sufficient temperature so as to form the substantially water insoluble composition, or biocidal surface coating.

The following options may be used in conjunction with the fourth aspect, either individually or in any suitable combination.

The sufficient temperature may be at least about 120° C. It may be about 120 to about 200° C. or may be higher than 200° C. The temperature may depend on the time of exposure of the coating to the temperature.

The heating may be for at least about 15 minutes after allowing the composition to at least partially dry. It may be for about 15 to about 60 minutes or even longer after allowing the composition to at least partially dry. It may be for less than 15 minutes after allowing the composition to at least partially dry. For example it may be for as short as ten seconds after allowing the composition to at least partially dry if a sufficiently high temperature is used. At 300° C., the heating may be 2 minutes or less, and at 400-500° C. it may be less than about 30 seconds.

The composition according to the first aspect may comprise a crosslinker comprising at least two functional groups, each being independently selected from the group consisting of epoxy, hydroxyl, thiol and amine. The crosslinker may be present at about 1 to about 10% by weight of the carboxyl functional polymer, or may be greater than about 10% by weight. Suitable crosslinkers include diols (e.g. 1,4-butanediol, ethylene glycol or mixtures of these) and epoxy resins or prepolymers, as well as mixtures of these.

In an embodiment there is provided a process for making a composition, or biocidal surface coating, according to the third aspect, said process comprising:
preparing a composition which is a solution, e.g. an aqueous solution, said composition comprising: a maleic acid-co-alkyl vinyl ether copolymer or a maleate-co-alkyl vinyl ether copolymer; crosslinking units derived from a crosslinker comprising at least two functional groups, each being independently selected from the group consisting of hydroxyl, thiol and amine; and alkyl benzyl dimethylammonium ions and/or dialkyl dimethylammonium ions (or other biocidal quaternary ammonium ions),
applying the composition to a surface;
allowing the composition to at least partially dry to form a film, commonly a tack free film; and
heating the composition to at least about 120° C. for at least about 15 minutes after allowing the film to at least partially dry, so as to form the substantially water insoluble composition, or biocidal surface coating.

In another embodiment there is provided a process for making a composition, or biocidal surface coating, according to the third aspect, said process comprising:
preparing a composition which is a solution, e.g. an aqueous solution, said composition comprising: a maleic acid-co-alkyl vinyl ether copolymer or a maleate-co-alkyl vinyl ether copolymer; crosslinking units derived from a crosslinker comprising at least two functional groups, each being independently selected from the group consisting of hydroxyl, thiol and amine; and alkyl benzyl dimethylammonium ions and/or dialkyl dimethylammonium ions (or other biocidal quaternary ammonium ions),
applying the composition to a surface;
allowing the composition to at least partially dry to form a film, commonly a tack free film; and
heating the film to at least about 300° C., e.g. about 300 to about 600° C. or about 500 to about 600° C., for less than about 2 minutes after allowing the composition to at least partially dry, so as to form the substantially water insoluble composition, or biocidal surface coating.

In another embodiment there is provided a process for making a substantially water insoluble composition, or biocidal surface coating, said process comprising:
combining a polymer, a biocidal quaternary ammonium salt and an liquid (e.g. water) so as to form a solution, said polymer comprising one or more of carboxylic acid groups, carboxylate groups and anhydride groups;
applying the solution to a surface;
allowing the composition to at least partially dry to form a film, commonly a tack free film; and
heating the film to at least about 120° C. for at least about 15 minutes after allowing the composition to at least partially dry, or to at least about 300° C., e.g. about 300 to about 600° C. or about 500 to about 600° C., for less than about 2 minutes after allowing the composition to at least partially dry, so as to form the substantially water insoluble composition, or biocidal surface coating.

In another embodiment there is provided a process for making a substantially water insoluble composition, or biocidal surface coating, said process comprising:
combining a maleic anhydride-co-alkyl vinyl ether copolymer or a maleic acid-co-alkyl vinyl ether copolymer or a maleate-co-alkyl vinyl ether copolymer or a mixture of any two or more of these, an alkyl benzyl dimethylammonium salt and/or a dialkyl dimethylammonium salt (or other biocidal quaternary ammonium salt), a crosslinker comprising at least two functional groups, each being independently selected from the group consisting of hydroxyl, thiol and amine and an liquid (e.g. water) so as to form a solution;
applying the solution to a surface;
allowing the composition to at least partially dry to form a film, commonly a tack free film; and
heating the film to at least about 120° C. for at least about 15 minutes after allowing the composition to at least partially dry or to at least about 300° C., e.g. about 300 to about 600° C. or about 500 to about 600° C., for less than about 2 minutes after allowing the composition to at least partially dry, so as to form the substantially water insoluble composition, or biocidal surface coating.

In another embodiment there is provided a process for making a composition, or biocidal surface coating, according to the third aspect, said process comprising:
preparing a composition in the form of a film on a surface, said composition comprising: a maleic acid-co-alkyl vinyl ether copolymer or a maleate-co-alkyl vinyl ether copolymer, a crosslinker comprising at least two epoxy groups (e.g. as an emulsion or dispersion of an epoxy resin or prepolymer); and alkyl benzyl dimethylammonium ions and/or dialkyl dimethylammonium ions (or other biocidal quaternary ammonium ions), and
heating said film to at least about 120° C. for at least about 15 minutes so as to form the substantially water insoluble composition, or biocidal surface coating.

In another embodiment there is provided a process for making a substantially water insoluble composition, or biocidal surface coating, said process comprising:
combining a maleic anhydride-co-alkyl vinyl ether copolymer or a maleic acid-co-alkyl vinyl ether copolymer or a maleate-co-alkyl vinyl ether copolymer or a mixture of any two or more of these, an alkyl benzyl dimethylammonium salt and/or a dialkyl dimethylammonium salt (or other biocidal quaternary ammonium salt), a crosslinker comprising at least two epoxy groups (e.g. as an emulsion or dispersion of an epoxy resin or prepolymer);
applying the solution to a surface;
allowing the solution to at least partially dry to form a film, commonly a tack free film; and
heating the film to at least about 120° C. for at least about 15 minutes after allowing the solution to at least partially dry or to at least about 300° C., e.g. about 300 to about 600° C. or about 500 to about 600° C., for less than about 2 minutes after allowing the solution to at least partially dry, so as to form the substantially water insoluble composition, or biocidal surface coating.

In a related process, described in the fifteenth aspect (below) no quaternary ammonium salt is used. In this case a hard film may still be obtained, as described in the fourteenth aspect (below). The film may be clear. It may be colourless.

In a fifth aspect of the invention there is provided use of a composition according to the first aspect, which is a solution comprising the polymer and the quaternary ammonium ions, for disinfecting a surface. The use may be a non-therapeutic use.

In a sixth aspect of the invention there is provided a method for disinfecting a surface comprising applying to said surface a composition according to the first aspect, which is a solution comprising the polymer and the quaternary ammonium ions. The method may be a non-therapeutic method. The surface may be a surface which is not a surface of a human. It may be a surface which is not a surface of a living organism.

In a seventh aspect of the invention there is provided use of a coating according to the third aspect for inhibiting biofilm growth on a surface.

In an eighth aspect of the invention there is provided a method for inhibiting biofilm growth on a surface, said method comprising forming a coating on said surface using the process of the fourth aspect.

In the use of the seventh aspect or the method of the eighth aspect, the surface may be a surface of a component of an air conditioning unit. The air conditioning unit may be a car air conditioner. Alternatively the surface may be an internal surface of a refrigerator or of a freezer. It may be some other surface which is frequently wet or damp. The surface may be the outer surface of the hull of a ship. In this case, the coating may be an antifouling coating. The surface may be a metal surface. In this case the coating may be a coating to prevent corrosion, e.g. acid induced corrosion.

In a ninth aspect the invention consists in a solution comprising an acidic polymer and a biocidal quaternary compound which forms a salt with the acidic polymer when baked.

In a tenth aspect the invention consists in a composition according to the ninth aspect further comprising a polyhydric alcohol which is soluble in the solution prior to baking.

In an eleventh aspect the invention consists in a composition according to the ninth aspect wherein the acidic polymer has some adjacent -[—C—R¹COOH—]- units and/or contains organic acid anhydride units.

In a twelfth aspect the invention consists in a composition according to the first or second aspect when coated on a surface and heated to above or 120° centigrade to form an indissoluble coating on the surface which inhibits microbiological growth on coated surfaces.

In a thirteenth aspect the invention consists in a composition according to any one of the ninth to twelfth aspects when coloured in the absence of a pigment.

In a fourteenth aspect of the invention there is provided a crosslinked polymer comprising polymer chains comprising maleic acid derived groups and crosslinking groups which crosslink the polymer chains through the maleic acid derived groups.

The following options may be used with the fourteenth aspect, either individually or in any suitable combination.

The crosslinked polymer may be in the form of a film. In this case, the film may be about 1 to about 100 microns thick, or may be thicker than this.

The crosslinked polymer may have a Shore D hardness of at least about 80. The crosslinked polymer may be hydrophilic. It may have a contact angle with water of less than about 90°, or less than about 60° or less than about 30°.

The crosslinked film may have no added pigment and may be coloured. In some instances the crosslinked polymer has no quaternary ammonium ions. In this case the film may be colourless and/or clear.

The polymer chains may be copolymer chains in which the maleate groups are one of the monomer units. The copolymer chains may be substantially alternating copolymer chains. The other comonomer may be a vinyl ether or an alkene, e.g. a linear or branched alkene.

The crosslinking group may be derived from a crosslinker having at least two groups capable of reacting with a carboxylic acid. Each of said groups may, independently, be an alcohol, a thiol, an amine or an epoxy, or may be some other suitable group. The crosslinker may therefore be a diol, or a bisepoxide or an epoxy prepolymer or resin or a diamine. It may be monomeric or it may be oligomeric or it may be polymeric.

In the event that polymer of this aspect is in the film additionally comprises biocidal quaternary ammonium ions, it may also come within the scope of the third aspect.

The crosslinked polymer may be made by the process of the fifteenth aspect (below).

In a fifteenth aspect of the invention there is provided a process for making a crosslinked polymer, said process comprising:
combining a maleic polymer with a crosslinker comprising at least two groups capable of reacting with a carboxylic acid and
heating the resulting mixture for sufficient time at a sufficient temperature for the maleic polymer to crosslink.

The term “maleic polymer” throughout the present specification signifies a polymer having either maleic acid groups or maleic anydride groups (collectively referred to as “maleic groups”) or both in the main chain. It may be a copolymer in which the maleic groups alternate with other groups, e.g. vinyl ether groups or alkene groups.

In the step of combining, the maleic polymer and the crosslinker may each, independently, be present in solution (e.g. aqueous solution) or in emulsion (e.g. in aqueous emulsion) or neat or in some other suitable form.

In the event that either the maleic polymer or the crosslinker is not present in neat form, the process may comprise the step of evaporating a solvent or carrier (e.g. water). This may be conducted at room temperature or it may be conducted at elevated temperature. In the latter case, the step of evaporating may be incorporated into the step of heating to crosslink, or it may be conducted as a discrete separate step.

The process may comprise forming a film of the combined maleic polymer and crosslinker prior to the step of heating.

In an embodiment, therefore, there is provided a process for providing a crosslinked polymer in the form of a film, said process comprising:
combining a maleic polymer with a crosslinker comprising at least two groups capable of reacting with a carboxylic acid, wherein at least one of the maleic polymer and the crosslinker is present in either solution or emulsion in a solvent (optionally an aqueous solvent);
applying said combined maleic polymer with crosslinker to a surface;
evaporating the solvent from said combined maleic polymer with crosslinker to form a film on the surface; and
heating the film for sufficient time at a sufficient temperature for the maleic polymer to crosslink.

The sufficient time and sufficient temperature may be sufficient for development of the desired hardness. It may be as described elsewhere herein, for example at least about 120° C. for at least about 15 minutes after evaporating the solvent or to at least about 300° C., e.g. about 300 to about 600° C. or about 500 to about 600° C., for less than about 2 minutes after evaporating the solvent.

In the event that a quaternary ammonium salt, e.g. a biocidal quaternary ammonium salt, is combined with the maleic polymer and crosslinker in the step of combining, the process may be within the scope of the fourth aspect. In this case, the sufficient time may be sufficient for development of colour in the film without the presence of a pigment. In some embodiments the process is conducted in the absence of quaternary ammonium ions.

The invention also encompasses a crosslinked polymer made by the process of the fifteenth aspect.

### DETAILED DESCRIPTION

The present invention relates to a biocidal coating composition which, in some embodiments, is applicable to a surface and which when dried and heated forms an adherent coating which resists biofilm growth and/or other microbial colonisiation for long periods. The coating may be hydrophilic. In some embodiments the coating adheres to untreated (un-primed) aluminium and may form a durable coating thereon. The coating may be coloured without requiring pigments, thus enabling coating integrity to be visually monitored. Thus the coating may be coloured so that the integrity and coverage of the surface can be visually inspected. As the colouring may be achieved without the addition of pigments, the coating is comparatively inexpensive. Additionally, colouration without using added pigments eliminates the possibility of toxic pigments or pigment derived substances being released from the coating into the environment and also allows for thinner, biocidally or biostatically effective coatings.

In a broad form, the present invention relates to a biocidal composition comprising a carboxyl functional polymer and biocidal quaternary ammonium ions and/or salts. The carboxyl functional polymer may be ionised (i.e. have anionic groups such as COO″) or un-ionised (i.e. have COOH groups) or may be partially ionised. The quaternary ammonium ions may be in the form of salts, either of the carboxyl functional polymer or of some other counterion (e.g. halide, sulfate, hydroxide etc.) or of both of these. They may be for example amine hydrohalides (e.g. hydrochlorides). Thus the composition may comprise the carboxyl function polymer and the biocidal quaternary ammonium ions wherein the polymer is ionised and the counterions of the polymer are the quaternary ammonium ions. The composition may comprise a salt of the quaternary ammonium ions (e.g. a quaternary ammonium halide, sulfate, hydroxide etc.) and the carboxyl functional polymer in either ionised or un-ionised form or a mixture of both. It may comprise a solution or film in which a carboxylate functional polymer, quaternary ammonium ions and other counterions (e.g. halide, sulfate, hydroxide etc.) are present, either associated with one another or unassociated with one another. The invention provides at least three related products, processes for making them and methods for using them.

The first of these products is a biocidal solution. This may be made by dissolving a suitable polymer and a biocidal quaternary ammonium salt in a liquid. The liquid may be an aqueous liquid or it may be a polar non-aqueous liquid such as ethanol, methanol, N-methylpyrrolidone, acetone etc. or mixtures thereof. The aqueous liquid may be water. It may additionally contain water soluble organic solvents such as ethanol, methanol etc. or may contain no organic solvents. In some embodiments, the only solvent present is water. It may additionally or alternatively contain salts other than the quaternary ammonium salt. The concentration of the polymer in the solution may be such that the solution is mobile, optionally so that it is sprayable. It may be about 0.1 to about 20% w/v, or about 0.1 to 10, 0.1 to 5, 0.1 to 2, 0.1 to 1, 0.1 to 0.5, 0.5 to 20, 1 to 20, 5 to 20, 10 to 20, 0.5 to 10, 0.5 to 5, 0.5 to 2, 1 to 10, 1 to 5 or 5 to 10%, e.g. about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15 or 20% w/v. It will be apparent that suitable concentrations will depend on the particular application and on the molecular weight of the polymer. Higher molecular weights of polymer will require lower is concentrations in order to maintain a suitable viscosity. The viscosity of the solution may be about 2 to about 2000 mPa·s, or about 2 to 1000, 2 to 500, 2 to 100, 2 to 50, 2 to 10, 10 to 2000, 100 to 2000, 500 to 2000, 1000 to 2000, 10 to 1000, 10 to 100, 100 to 500 or 500 to 1000 mPa·s, e.g. about 2, 3, 4, 5, 6, 7, 8, 9, 10, 20, 30, 40, 50, 60, 70, 80, 90, 100, 150, 200, 250, 300, 350, 400, 450, 500, 600, 700, 800, 900, 1000, 1500 or 2000 mPa·s. In some instances the solution may be provided as a concentrate, for example with a solids content of up to about 60% w/v, or up to about 50, 40 or 30% w/v. Such concentrates may in some cases be not sprayable, but may be diluted to a concentration (e.g. as described above) at which they are sprayable. The diluent in this case may be the liquid described above.

The second of the products is a biocidal film. It may be obtained by applying the biocidal solution described above to a surface and allowing the solution to at least partially dry, by at least partially evaporating the liquid of the solution. The at least partial drying may be to the stage where the film is tack free to touch. It may therefore contain the same components as the solution with the exception that the liquid is either absent or is present in relatively low concentration, e.g. less than about 10% by weight, or less than about 9, 8, 7, 6, 5, 4, 3, 2 or 1%, or at a concentration of about 0.1, 0.5, 1, 2, 3, 4, 5, 6, 7, 8, 9 or 10% by weight. This film may serve to disinfect the surface. The biocidal solution may be applied to the surface by spraying, wiping, rolling or by some other method. The resulting film may be about 1 to about 100 microns thick, or may at times be more than 100 microns thick. It may be about 1 to 50 microns thick, or 1 to 20, 1 to 10, 1 to 5, 5 to 100, 10 to 100, 20 to 100, 50 to 100 or 10 to 50 microns thick, e.g. about 1, 2, 5, 10, 20, 30, 40, 50, 60, 70, 80, 90 or 100 microns thick. The film may be water soluble. It may retain its biocidal effectiveness for at least about 1 hour, or at least about 6, 12 or 24 hours under normal use, including adventitious water exposure. It may if required be readily washed off in a suitable liquid, e.g. water. The film may be tack free. The step of allowing the solution to at least partially dry so as to form the film may comprise spreading the solution on a surface or otherwise applying it to the surface. It may comprise the step of exposing the so applied solution to a free flow of air. It may comprise exposing it to dry air, or to air having a lower than normal moisture content, or to some other gas, e.g. nitrogen. The other gas may be a dry gas. It may comprise passing the air or gas over the surface of the solution. The gas may be at room temperature, or may be at slightly elevated temperature, e.g. up to about 50° C., or about 20, 25, 30, 35, 40, 45 or 50° C., sometimes higher. As noted elsewhere, it may be convenient to make the solution at elevated temperature, at times up to about 90° C. In such cases the film may be formed by applying the solution shortly after it is made (and therefore at approximately the temperature at which it is made) to the surface. The elevated temperature of the solution on the substrate will then facilitate evaporation of the liquid. As this occurs, the solution (and forming film) will naturally cool, due to evaporative cooling and/or due to heat transfer to the substrate and/or to the surrounding atmosphere.

The third of the products is a hard biocidal film. It may be obtained by heating the biocidal film described above. Commonly a crosslinker such as a diol or polyol or an epoxy resin will be added to the composition prior to curing to enhance the flexibility and/or hardness achieved on heating, however this is not a necessary requirement. The hard biocidal film may be hydrophilic. It may have a water contact angle at 25° C. of less than about 90°, or less than about 60, 45, 30, 20 or 10°, e.g. of about, 0, 1, 2, 3, 4, 5, 10, 15, 20, 25, 30, 35, 40, 45, 50, 55, 60, 65, 70, 75, 80, 85 or 90°. The hard film may have good unprimed adhesion to suitable substrates, e.g. to metals such as steel (e.g. stainless steel), aluminium, brass etc. It may have good unprimed adhesion to all of these or to only one or some of them. The hard film may be substantially insoluble in water. It may have a saturation concentration in water at 25° C. of less than about 100 ppm (w/v/), or less than about 50, 20, 10, 5, 2, 1, 0.5, 0.2 or 0.1 ppm. It may be slow to dissolve in water. The hard film when subjected to continuously flowing water at 25° C. may dissolve at a rate of less than about 10 microns per day, or less than about 5, 2, 1, 0.5, 0.2 or 0.1 microns per day. In some cases a film of under 10 microns may last for up to 10 years, sometimes more. The rate of dissolution, as described above, may therefore be as low as 1 to 20 Angstroms/day, or 1 to 10, 1 to 5, 50 to 20 or 10 to 20 Angstroms/day, e.g. about 1, 2, 3, 4, 5, 10, 15 or 20 Angstroms/day. It will be understood that the hard film is intended to resist dissolution in water. This may be achieved by having a low saturation solubility (i.e. a thermodynamic insolubility) or a low rate of dissolution (i.e. a kinetic insolubility) or both.

The inventors have surprisingly found that formation of the hard biocidal films is accompanied by development of colour in the absence of added pigment. Typically the film will develop a red or purple colouring. On further heating this red or purple colour may change to gold or brown. This colour change is commonly associated with an improvement in properties of the film (e.g, water resistance). The coloured films generally show excellent unprimed adhesion to common substrates such as aluminium and steel. This colouring is useful in facilitating identification of surfaces having the coating thereon, and obviates the need to add pigments which can be expensive, can release toxic materials to the environment and/or can interfere with chemistry occurring in the film (e.g. during cure). Additionally, the colour may be advantageous in indicating the degree of cure achieved during the heating. Where more than one colour is developed, the colour at a particular time may indicate the degree of cure that has been achieved at that time. In the present context, “cure” refers to the thermally promoted hardening of the film. This is thought to be associated with a crosslinking reaction within the film. The development of colour in the hard film may be used as a means to determine when the cure reaction is sufficiently advanced. Thus it may be convenient to heat the uncured film for sufficient time to develop the colour or colours, or to develop a desired colour or colours, at which stage the film will have developed sufficient hardness. It is thought that the minimum requirement for colour formation is the presence of a vicinal dicarboxylic acid group or an anhydride thereof, for example in the form of a maleic anhydride/vinyl ether copolymer or an at least partially hydrolysed derivative thereof, a quaternary ammonium salt which may be a biocidal quaternary ammonium salt, and a heat source. In some cases the heating may not be necessary, however in these cases other components are required. Colour development appears to depend on the presence of a quaternary ammonium salt. It has been observed on heating a maleic anhydride/vinyl ether copolymer with a quaternary ammonium salt or with mixtures of such salts. The inventors also consider that colour may develop on heating other carboxylic functional polymers having adjacent carboxyl groups in the presence of quaternary ammonium salts.

A related product is the same as described above but lacking the quaternary ammonium ions. It may have very similar physical properties (including appearance) but may lack biocidal or bioinhibitory properties. Such films may be made by a similar process to that described above, however the quaternary ammonium salt is omitted from the biocidal solution which is its precursor. These films are commonly colourless unless a separate pigment has been added. They may be clear.

The inventor has observed that, once colour has developed (commonly a red or purple colour), continued heating converts the colour to brown or gold. The resulting brown colour may be even across the film. The brown hard film may be transparent, or substantially transparent. The inventor considers that the colour change to brown is unlikely to represent an oxidation reaction, as the film retains its flexibility during the colour change. It also retains its biocidal properties during the colour change. Additionally the coating with the brown colour exhibits greater resistance to water than the intermediate red/purple film. These physical properties may be due to a higher degree of cross-linking in the brown or gold film relative to the red or purple film. The brown coloured film commonly retains excellent unprimed adhesion to common substrates (glass, aluminium, steel etc.) and biocidal properties after 8 hour exposure to boiling water. The cured film (red/purple or gold/brown) may have excellent resistance to acids. It may show no visible deterioration after exposure to mineral acid for up to 1 hour. The mineral acid may be 1N or may be more than 1N, e.g. 1.5, 2, 3, 4 or 5N.

The colour of the films may be partially extracted into certain solvents. It may also fade on exposure to sunlight or to UV radiation. The faded film was observed to redevelop colour on reheating under the conditions originally used to form the colour. The faded film commonly retains some colour but with reduced intensity. The faded film still retains the excellent physical and biocidal/biostatic properties of the unfaded film.

The hard films may be flexible. They may be capable of withstanding a bend of the substrate of about 30° without cracking, or of about 40, 50, 60, 70, 80, 90, 120, 150 or 180°. In the test, the film may have a thickness as described elsewhere herein. The bend may be around a mandrel of diameter of less than 5 mm, or less than 4, 3, or 2 mm, e.g. of diameter about 1, 2, 3, 4 or 5 mm.

The inventor has found that epoxy materials, e.g. oligomers, resins, prepolymers or polymers, potentially in combination with epoxy reactive diluents, may be used as the crosslinker for the polycarboxylic/quaternary ammonium biocide combination or indeed for the carboxylic polymer without quaternary ammonium biocide. The resulting epoxy cross-linked films appear to have improved water resistance and corrosion resistance, particularly against alkalis, relative to films crosslinked using diols. The epoxy material may be used in the form of an emulsion.

Formulations incorporating epoxy compounds may utilise the same polymer/quaternary ammonium biocide combinations (or the same polymer in the absence of biocide) as described elsewhere herein. Any polyhydroxy component present in the composition may however be replaced by an epoxy resin, commonly although not necessarily as an emulsion. Such emulsions may comprise non-ionic surfactants as emulsifiers, for example non-ionic ethoxylate or non-ionic ethoxylate/propoxylate copolymer surfactants. The epoxy resin may be diluted with a proportion of a reactive diluent such as a glycidyl ether. Suitable reactive diluents include phenyl glycidyl ether, butyl glycidyl ether, allyl glycidyl ether or even related compounds such as octylene is oxide or glycerol based epoxide or diepoxide resins. Suitable diluents may be used in combination.

The incorporation of an epoxy resin into a composition which is then heated to form a cross-linked biocidal film may achieve increased water resistance and even more significantly improved corrosion resistance against alkalis relative to films which are not made using epoxy crosslinkers. It should be particularly noted that the use of the non-ionic surfactants as described above does not impair the improved water resistance and corrosion resistance of the resulting film as might have been expected by incorporation of such hydrophilic molecules into dry coatings. It is thought that this is because these surfactant molecules have terminal hydroxyl groups, which can also react with the carboxylic acid or carboxylic acid anhydride group of the polymer upon heating. This has been illustrated in examples where a Teric® surfactant (a hydrocarbon ethoxylate) is incorporated. This esterification step eliminates the surfactant as an independent water soluble molecule which might otherwise compromise the physical properties of the film. It has also been noted by the inventor that an alternative surfactant or surfactant system based on non-ionic or cationic fluorocarbon surfactants (such as from Dupont's Zonyl® range) may be used alone or in combination with non-ionic ethoxylates such as described above.

The hard film may have a Shore D hardness of at least about 80, or at least about 85, 90 or 95, or of about 80 to 100, 90 to 100 or 80 to 90, e.g. about 80, 85, 90, 95 or 100. The hard film may be sufficiently durable to retain its physical and biocidal properties in use in an air conditioning unit for at least about 1 month, or for at least 2, 3, 4, 5, 6, 7, 8, 9, 10, 11 or 12 months, or for at least about 2, 3, 4 or 5 years, in some cases longer (e.g. 10, 15 or 20 years). Suitable biocidal properties are the ability to resist growth of microorganisms on the surface thereof. Suitable microorganisms which may be inhibited in this way may include any or all of bacteria, fungi, amoebae, algae and other microorganisms. These may be pathogenic microorganisms.

The products described above may be defined by the processes for making them and/or by the properties provided herein for them.

The biocidal solution described above may be made by combining a polymer, a biocidal quaternary ammonium salt and a liquid (which may be a solvent for the polymer and/or for the salt), e.g. an aqueous liquid, so as to form a solution, wherein the polymer may have functional groups which are or can be hydrolysed to form carboxyl groups (—COOH or —COO⁻). Thus the polymer may comprise anhydride groups. It may comprise one or more of maleic acid monomer units, maleate monomer units, (meth)acrylic acid monomer units and maleic anhydride monomer units. In the present specification, where mention is made of maleic acid monomer units, or similar, this should be taken to refer to monomer units which would be present if maleic acid monomer were polymerised or copolymerised. Thus in the case of maleic acid monomer units themselves, these would represent butanedioic acid-2,3-diyl groups (—CH(COOH)—CH(COOH)—). The maleate monomer units may be dianions or may be monoanions (—CH(CO₂⁻)—CH(CO₂⁻-) or (—CH(CO₂⁻)—CH(CO₂H—) respectively. The polymer may be a homopolymer or may be a copolymer. Suitable comonomers include vinyl ether comonomers such as methyl vinyl ether, ethyl vinyl ether, phenyl vinyl ether etc. Other suitable comonomers include alkenes, for example primary alkenes (i.e. terminal alkenes). The substituent, or each substituent independently, on the double bond of the alkene may be hydrogen, alkyl or aryl. The alkyl group may be C1 to C10, or C1 to C6 or C6 to C10 or C2 to C6, e.g. C1, C2, C3, C4, C5, C6, C7, C8, C9 or C10. It may be linear, or may be branched. It may be cyclic or acyclic. It may for example be methyl, ethyl, propyl, isopropyl, butyl, isobutyl, pentyl, neopentyl etc. The comonomer may for example be isobutylene (in which case the polymer may be Isobam™ from Kuraray Co., Ltd.). The copolymers may be random copolymers or may be alternating copolymers or may be block copolymers or may be some other type of polymers. They may be isotactic, or may be syndiotactic or may be atactic. They may have both comonomers in the backbone of the polymer. The molecular weight of the polymer may be from about 10 to about 5000 kDa, or about 10 to 1000, 10 to 500, 10 to 200, 10 to 100, 10 to 50, 10 to 20, 50 to 5000, 100 to 5000, 500 to 5000, 1000 to 5000, 50 to 1000, 50 to 500, 50 to 100 or 100 to 500 kDa, e.g. about 10, 20, 30, 40, 50, 60, 70, 80, 90, 100, 150, 200, 250, 300, 350, 400, 450, 500, 600, 700, 800, 900, 1000, 1500, 2000, 2500, 3000, 3500, 4000, 4500 or 5000 kDa. Suitable polymers are available from International Specialty Polymers as Gantrez® AN copolymers at molecular weights (approximate weight average) of 216, 800, 1080, 1250, 1980 and 2400 kDa and Gantrez® S copolymers at molecular weights (approximate weight average) of 216, 700 and 1500 kDa. In the process for making the biocidal solution, the polymer to may be used in solution. The solution may be about 0.1 to about 20% w/v, or about 0.1 to 10, 0.1 to 5, 0.1 to 2, 0.1 to 1, 0.1 to 0.5, 0.5 to 20, 1 to 20, 5 to 20, 10 to 20, 0.5 to 10, 0.5 to 5, 0.5 to 2, 1 to 10, 1 to 5 or 5 to 10%, e.g. about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15 or 20% w/v or higher (e.g. about 25, 30, 35, 40, 45 or 50%). It may be an aqueous solution. It may be a solution in an aqueous solvent. The aqueous solvent may comprise a water miscible organic solvent, for example methanol or ethanol or it may comprise no organic solvent.

The biocidal quaternary ammonium salt used in making the biocidal solution may be an alkyl benzyl dimethylammonium salt or a dialkyl dimethylammonium salt (although other biocidal quaternary ammonium salts may also be used). In either case, each alkyl group independently may be C1 to C20, or C1 to C18, C1 to C12, C1 to C6, C6 to C20, C10 to C20 or C10 to 18, e.g. C1, C2. C3, C6, C10, C12, C14. C16, C18 or C20. In some instances the alkyl group may be a mixture of different chain lengths. This is commonly the case when the alkyl chains are derived from natural sources. In that case, the above chain lengths may be the predominant chain length. Mixtures of quaternary ammonium salts may be used. The anion of the quaternary ammonium salt may be a halide, e.g. chloride or bromide, or may be some other suitable anion. Suitable quaternary ammonium salts for use in the invention include didecyl dimethyl ammonium chloride (e.g. Bardac® 2250 and 2280 from Lonza) and N-alkyl dimethyl benzyl ammonium chloride (e.g. JAQ® Powdered Quat from Lonza), chlorhexidine gluconate etc. The quaternary ammonium salt may be used in solution, e.g. in aqueous solution. The solution may have a concentration of quaternary ammonium salt from about 1 to about 90% w/v, or about 10 to 90, 20 to 90, 50 to 90, 70 to 90, 1 to 50, 1 to 20, 1 to 10 or 10 to 50%, e.g. about 1, 2, 3, 4, 5, 6, 7, 8, 9, 10, 15, 20, 25, 30, 35, 40, 45, 50, 60, 70, 80 or 90% w/v. The solution may additionally contain cosolvents, e.g. an alcohol (methanol, ethanol etc.), a ketone or an ester. In many cases no organic cosolvent is present, commonly no cosolvent of any sort. When preparing the biocidal solution, the polymer and the quaternary ammonium salt may be combined such that the polymer is in equal or greater weight than the quaternary ammonium salt. They may be in a weight ratio (on a solids basis) of polymer to quaternary ammonium salt of 1 to about 50 polymer to quaternary ammonium salt (i.e. about 1:1 to about 50:1) about 5 to about 50 (i.e. 5:1 to about 50:1), or about 1 to 20, 5 to 20, 5 to 10, 10 to 50, 20 to 50 or 10 to 20, e.g. about 1, 2, 3, 4, 5, 10, 15, 20, 25, 30, 35, 40, 45 or 50. The mixing may be such that the molar ratio of quaternary ammonium ions to carboxyl groups or equivalents is less than 1. The ratio may be less to than 0.9, 0.8, 0.7, 0.6, 0.5, 0.4, 0.3 or 0.2, or may be about 0.1 to about 1 or about 0.1 to 0.5, 0.5 to 1 or 0.2 to 0.5, e.g. about 0.1, 0.2, 0.3, 0.4, 0.5, 0.6, 0.7, 0.8, 0.9 or 1. In this context, “carboxyl groups or equivalents” refer to CO₂H groups which would be present if the polymer were fully protonated and, if anhydride groups are present, hydrolysed. Thus each CO₂H and CO₂⁻ group represents a carboxyl group or equivalent and each anhydride group represents two carboxyl groups or equivalent. It is hypothesised that in forming the biocidal solution described herein, at least some anhydride groups on the polymer (if these are present) hydrolysed to form carboxyl groups. An association may form between the carboxyl groups of the polymer and the quaternary ammonium groups in the solution. When the solution is dried to form a film, it is hypothesised that this forms a polymeric quaternary ammonium carboxylate structure which provides biocidal properties.

The inventors have observed that in some instances, when combining a solution of the polymer with a solution of the quaternary ammonium salt, a precipitate is initially formed in the resulting aqueous mixture. However this precipitate redissolves over time to form a solution representing one form of the composition of the invention. Commonly the step of combining the copolymer with the quaternary ammonium salt is performed at elevated temperature, e.g. over about 65° C., or over 70, 75, 80, 85 or 90° C., or at about 65, 70, 75, 80, 85, 90 or 95° C. This is due to practical considerations, since the dissolution of the copolymer is commonly slow at lower temperatures. Consequently in order to speed dissolution of the copolymer in an aqueous liquid, the liquid is commonly heated. It is convenient then to use this solution at the elevated temperature, although the inventors have observed that if the copolymer solution is cooled, for example to ambient temperature, the process proceeds in the same manner as at the elevated temperatures described above.

The biocidal composition of the invention, or, independently, the quaternary ammonium salt from which it is made, may be biocidal and/or biostatic towards fungi, or towards fungal spores, or towards bacteria, or towards bacterial spores, or towards viruses, or towards amoebae, or towards algae or towards algal spores or towards any two or more of these. It may be fungicidal, fungistatic, bactericidal, bacteriostatic, amoebicidal, amoebistatic, viricidal, algaecidal, algaestatic or any two or more of these. In the context of this specification, the term “biocidal” refers to a material which resists biofilm growth and/or other microbial colonisation on its surface, or which inhibits or prevents growth of microorganisms or which kills microorganisms. It therefore encompasses biostatic materials. A biocidal composition according to the invention may be capable of one or more than one of these. It should be understood that a biocidal film may resist growth of microorganisms on its surface without exhibiting a substantial zone of inhibition if the biocidal (i.e. inhibitory) component is not mobile. Thus the zone of inhibition surrounding a sample of the composition is not necessarily a good indicator of the biocidal effectiveness of the composition. Accordingly any of the biocidal coatings of the present invention, in particular those in film form, may be regarded as bioresistive or bioinhibitory or biostatic.

The inventors have found that the biocidal compositions described above in the form of a solution may be used for disinfecting surfaces. Thus the solution may be sprayed, rolled, wiped or otherwise applied to a surface and then at least partially dried to form a film on the surface. This may be simply by air drying. It may comprise passing a stream of gas, e.g. air, over the surface of the film. It may comprise heating the film. The heating may be to a suitable drying temperature, e.g. about 40 to about 100° C., or about 40 to 80, 40 to 60, 60 to 100, 80 to 100 or 60 to 80° C., e.g. about 40, 60, 80 or 100° C.

The inventors have further found that on heating films of the biocidal compositions to higher temperatures, the films convert to a hard, water insoluble film which retains its biocidal properties. Suitable temperatures for this conversion (“curing temperatures”) are from about 120° C. to about 250° C., or about 120 to 200, 120 to 150, 150 to 250, 200 to 250 or 150 to 200° C., e.g. about 120, 130, 140, 150, 160, 170, 180, 190, 200, 210, 220, 230, 240 or 250° C. In some cases even higher temperatures may be used. The temperature should not be sufficiently high as to cause degradation of the properties (physical, biocidal) of the film. The time required for curing of the compositions to a hard film varies considerably depending on the nature of the composition and the curing temperature used. It may be at least about 15 minutes, or at least about 30, 45 or 60 minutes or longer than 60 minutes, or may be for about 15 to about 60 minutes or longer than 60 minutes, or about 15 to 30, 30 to 60 or 30 to 45 minutes, e.g. about 15, 20, 25, 30, 35, 40, 45, 50, 55 or 60 minutes or longer than 60 minutes. In some instances curing may be effected in a shorter time, e.g. about 5, 6, 7, 8, 9, 10, 11, 12, 13, 14 or 15 minutes. In some instances, high heating for short times may also cure the films to the hard biocidal film. For example temperatures of at least about 300° C. may be used, or at least 350, 400, 450 or 500° C., or about 300 to about 600° C., or about 300 to 400, 400 to 500, 500 to 600 or 350 to 550° C. (e.g. about 300, 350, 400, 450, 500, 550 or 600° C.). Typically at about 300° C., times of about 2 minutes or less are sufficent, and at 400-500° C. times of 30 seconds or less are sufficient. At sufficiently high temperatures heating times of as little as about 10 seconds may suffice, for example less than about 60, 50, 40, 30, 20 or 10 seconds, or about 10 to about 60 seconds, or about 10 to 30, 10 to 20, 20 to 60, 30 to 60 or 15 to 30 seconds, e.g. about 10, 15, 20, 25, 30, 35, 40, 45, 50, 55 or 60 seconds. At such short times, the high temperatures may not cause unacceptable degradation to the film. This is particularly effective in cases where heat transfer times are not significant. Typically this is for films less than about 25 microns thick, or less than about 20, 15, 10 or 5 microns thick, for example films of thickness about 1, 2, 3, 4, 5, 10, 15, 20 or 25 microns. Common film thicknesses are around 1 to 5 microns or around 1 to 3, 3 to 5 or 5 to 10 microns.

The physical properties of the film may be improved by addition of a crosslinker to the solution from which it is made. This will commonly be a polyol, but may comprise other groups capable of reacting with carboxyl or anhydride groups, e.g. thiols and/or amines. Generally the crosslinking species will have a formula R(XH)ₙ, where R is a backbone, for example an alkyl group, an aryl group, a heteroaryl group etc., each X is independently selected from O, S and NH, and n is an integer greater than 1 (e.g. 2, 3, 4, 5, or more than 5). Alternatively or additionally, the crosslinker may be an epoxy resin, prepolymer or polymer, or a diepoxide or the episulfide or aziridine equivalents thereof. Suitable examples include 1,4-butanediol, 1,2-propylene glycol, 1,3-propylene glycol, ethylene glycol, 1,5-pentanediol, polyvinylalcohol (or partially hydrolysed polyvinylacetate), glycerol, sorbitol, polyethylene glycol, pentaerythritol, chlorhexidine, triethanolamine, ethanolamine, hexamethylene diamine, polyethylene oxides, poly(ethylene oxide-co-propylene oxide), an amine in which each group on the amine nitrogen is an oligoethylene oxide or an oligo(ethylene oxide-co-propylene oxide), 1,4-butane diol bisglycidyl ether, Bis-phenol A diglycidyl ether etc. and mixtures of any two or more of these. These may be used in a ratio of about 1:1 to about 10:1 relative to the polymer (by weight, or by mole equivalent to polymer hydroxyl groups), or about 1:1 to 1:5, 1:1 to 1:2, 1:2 to 1:10, 1:5 to 1:10 or 1:2 to 1:5, e.g. about 1:1, 2:3, 1:2, 2:5, 1:3, 2:7, 1:4, 1:5, 1:6, 1:7, 1:8, 1:9 or 1:10, or some other suitable ratio. Any or all of these may be supplied to the composition in the form of an emulsion. The emulsion may be stabilised by a surfactant. The surfactant may be capable of being immobilised in a resulting film, e.g. by reaction with the polymer. It may be a functional surfactant. It may be a hydroxyfunctional surfactant. As noted earlier, the composition, when in the form of a solution, may have no organic solvents. Any crosslinkers present should not be regarded in this context as a solvent, even if it does possess some solvent properties. Thus the solution may contain no organic solvents that can not perform as crosslinkers for the polymer. It may contain no organic mono-alcohols. In this context, “no” organic solvent (or organic mono-alcohols) should be taken to indicate no significant quantities thereof, e.g. less than about 100 ppm, or less than about 10, 1 or 0.1 ppm (on a w/v basis).

Suitable test methods for use with the products describe herein are set out below:

ASTM D522-938 (2005) Standard Test Method for Mandrel Bend Test of attached organic coating

ISO1519-2011-08-22 Bend test for paints and varnishes by cylindrical mandrel

ASTM D968-05 (2010) Standard Test Method for abrasion resistance of organic coatings by falling abrasives

ASTM D144-08 Standard Test Method resistance of transparent plastics to surface abrasion

ASTM D4060-10 Standard Test Method for abrasion resistance of organic coatings by the Taber Abraser ASTM 523-08 Standard Test Method for specular gloss

ASTM D2457-08 e1 Standard Test Method for specular gloss of plastic films and solid plastics

ASTM E430-11 Standard Test Method for measurement of gloss of high gloss surfaces by abridged goniophotometry

ASTM D3363-06 (2011) Standard Test Method for film hardness by pencil test.

ISO15184: 1998 Test for paints and varnishes to determine film hardness by the Pencil Test

ASTM D870-09 Standard Test Method for testing water resistance of coatings using water resistance

ASTM D2247-11 Standard Practice for testing water resistance of coating in 100% relative humidity

ASTM D2197-10 Standard Test Method for adhesion of organic coatings by scrape adhesion

ASTM D3359-09 e2 Standard Test Method for measuring adhesion by tape test

ASTMD4541-09 e1 Standard Test Method for pull of strength of coating using portable adhesion testers

ISO4624-2002 Test for paints and varnishes to Assess adhesion pull off strength

ASTM D 2794-93 (2010) Standard Test Method for resistance of organic coatings for the effect of rapid deformation (impact)

ISO2409:2007 Test Method for paints and varnishes to assess resistance to separation of substrates

ISO 2815-2001 Test Method for paints and varnishes to assess resistance of deformation by the Buchholz indentation test

ASTM D1308-02 (2007) Standard Test Method of household chemicals on clear or pigmented organic finishes

ASTM D2248-01a (2007) Standard Practice for detergent resistance of organic finishes

ASTM D3450 Standard Test Method for washability properties of interior architectural coatings

ISO11998: 2006 Test for paints and varnishes to determine wet scrub resistance and cleanability of coatings

ASTM D3002-07 Standard Guide for evaluation of coatings applied to plastics ASTM D3170-03 (2007) Standard Test Method for chipping resistance of coatings ASTM D5589 Standard Test Method for determining resistance of painted films and related coatings to algal defacement.

ASTM D5590 Standard Test Method for determining resistance of painted films and related coatings to fungal attack.

ASTM D3273 Standard Test Method for resistance to growth of mould on the surface of interior coatings in an environmental chamber.

JIS Z 2801-2000: Antimicrobial products test for antimicrobial activity and efficacy.

Examples of successful test results achieved with the following formulation are included hereafter:

Formulation

| | | |
|---|---|---|
| Water | 75-85% | |
| Polymer | 5-15% | poly(vinylmethyl ether-co-maleic anhydride) |
| Biocide | 1-10% | didecyldimethylammonium chloride |
| Glycol | 1-5% | |

The test results demonstrate the variation in properties achieved with the coating at the first stage of cure, i.e. red-purple and at the second stage of cure ie gold-brown. These to cures were achieved with the following curing cycles:

red-purple: 30 mins at 150° C. after drying at ambient temperature;

gold-brown: 20 mins at 170° C. after drying at ambient temperature.

As is evidenced by the testing, the second stage of cure achieves significantly superior moisture, water and saline resistance and superior corrosion resistance. Physical testing properties were similar for both coatings.

Notably the gold-brown coating exhibits sufficient water resistance as to evidence little to no change after being cured onto unanodised aluminium and being boiled for 6 hours.

It is further notable that the coatings, particularly the gold-brown coating, exhibit excellent protection against acid corrosion. In comparison the protection of both the red-purple and gold-brown coatings against alkalis and soluble phosphates is somewhat inferior to that afforded against acids, although some resistance to these under relatively mild conditions has been observed. The alkali and soluble phosphate resistance of the coatings is enhanced with the incorporation of reactive epoxide moieties into the cured polymer matrix.

Various aspects of the invention may be used for disinfecting surfaces or for use in treating air conditioning units or other devices having surfaces prone to buildup of biofilms or microbial infestation. In its crosslinked form, the invention may be used as an antifouling coating for surfaces which come in contact with a marine environment, e.g. the hulls of ships or boats.

In summary, there are several forms of the composition of the present invention:
1) a solution, commonly aqueous, comprising a biocidal quaternary ammonium salt and a carboxyl functional polymer—this may be used as a disinfectant, e.g. as a spray. The spray generally kills microorganisms on contact and may leave an intact film (see 2 below) which continues to protect the surface against microbial colonisation for some time;
2) a film comprising biocidal quaternary ammonium ions and a carboxyl functional polymer—this may be the film obtained by spraying the solution of 1) onto a surface and evaporating the majority of the solvent. It may represent a disinfecting film, or a precursor to the film 3) (particularly if it contains a crosslinker), and is commonly water soluble which kills microorganisms on contact and leaves an intact film which continues to protect the surface against microbial colonisation for some time. The film may be non-tacky to touch;
3) a hard, commonly crosslinked, film derived from biocidal quaternary ammonium ions and a carboxyl functional polymer (optionally a maleic polymer), in general from the film of 2) by heating. This heating drives off residual solvent and is thought to crosslink the film. Generally the film 2) used to make the film 3) contains a crosslinker, e.g. an emulsified epoxy resin or a diol, although other crosslinkers or mixtures thereof may be used. The film is coloured when sufficient curing has taken place, even in the absence of added pigment or colouring agents when at least one quaternary ammonium compound was added, and when sufficiently cured resists growth of microorganisms on its surface for an extended period, typically years and may do so even when the surface which is coated is intermittently wet.
4) A transparent crosslinked polymer, commonly in the form of a film, derived from a maleic polymer and optionally a crosslinker.

Processes for making these and uses for these have been described.

### EXAMPLES

### Materials

The following commercially available products were used in the following experiments:
Gantrez® AN 119: poly(vinylmethyl ether-co-maleic anhydride), approx. Mw 216000 available from International Specialty Polymers (ISP)
Gantrez® AN139: poly(vinylmethyl ether-co-maleic anhydride), approx. Mw 1080000 available from International Specialty Polymers (ISP)
Gantrez® S95: poly(vinylmethyl ether-co-maleic acid), approx. Mw 216000 available from International Specialty Polymers (ISP)
Barquat® MB80: Alkyl (C14 50%, C16 10%, C12 40%) dimethyl benzyl ammonium chloride
Bardac® 2280: didecyldimethylammonium chloride 80% in 1:1 ethanol/water available from Lonza Inc.
Teric® N300: nonylphenolethoxylate available from Huntsman Corp.
Teric® N30: nonylphenolethoxylate available from Huntsman Corp.
Lonza® JAQ: N-alkyl(C₁₄ 95%, C₁₆ 2%, C₁₂ 3%) dimethyl ammonium chloride available from Lonza Inc.
Carbopol® 940: crosslinked polyacrylate polymer available from Lubrizol.

### Experiments

The formulations below show the percentages of the various components in the dry coating. In those cases where the totals do not sum to 100% the numbers represent weight ratios of components. Each was deposited by evaporation of an aqueous solution, an anhydrous solution or a dispersion. In some of the coatings solvents, such glycol ethers, have been included.

In each case of the first series (Experiments 1 to 17) the coating, upon drying at ambient temperature, produced a clear, colourless film which provided an excellent zone of inhibition against Staphylococcus aureus.

Subsequently each of the films that incorporates functional groups which react with carboxylic or acid anhydride groups was baked for 30 minutes at 150° C. In each case the resulting film was a clear hard coating with a strong purple cerise colour.

| | 1 | 2 | 3 | 4 | 5 | 6 | 7 | 8 | 9 |
|---|---|---|---|---|---|---|---|---|---|
| Polyvinylalcohol low m. wt., | 71.1 | 71.2 | 65.8 | 60.8 | 71.8 | 65.8 | 60.8 | 71.8 | 71.8 |
| 88% hydrolysis | | | | | | | | | |
| Gantrez ® AN119 | 17.8 | 17.9 | 16.5 | 15.2 | 18.0 | 16.5 | 15.2 | 18.0 | 18.0 |
| Benzalkonium chloride: | 11.1 | 10.9 | 1.0 | 0.9 | 1.1 | 1.0 | 0.9 | 1.1 | 1.1 |
| Barquat ® MB80 | | | | | | | | | |
| N-methyl-2-pyrrolidone | | | 16.7 | 23.1 | | | | | |
| Dipropylene glycol methyl | | | 9.1 | 16.7 | 23.1 | 9.1 | | | |
| ether | | | | | | | | | |
| Propylene glycol n-propyl | | | | | | | | | 9.1 |
| ether | | | | | | | | | |

| | 10 | 11 | 12 | 13 | 14 | 15 | 16 | 17 |
|---|---|---|---|---|---|---|---|---|
| Polyvinylalcohol | 17.8 | 71.1 | 17.8 | 53.3 | 44.5 | 26.7 | 62.2 | 35.6 |
| low m. wt., | | | | | | | | |
| 88% hydrolysis | | | | | | | | |
| Gantrez ® | 17.1 | 17.8 | 71.1 | 35.6 | 44.5 | 62.2 | 26.7 | 53.3 |
| AN119 | | | | | | | | |
| Benzalkonium | 11.1 | 11.1 | 11.1 | 11.1 | 11.1 | 11.1 | 11.1 | 11.1 |
| chloride: | | | | | | | | |
| Barquat ® MB80 | | | | | | | | |

In the subsequent series various polyalcohols were tested, either alone or in combination, to investigate whether they would provide the same properties as the polyvinylalcohol.

Experiments 18, 19 and 20 did not incorporate any polyacid, and were composed purely of polyalcohol and quaternary biocide. None of these coatings produced a water insoluble film either upon drying or heat curing. Most notably no colour was developed upon curing.

Experiments 37, 38 and 39 incorporated a nonylphenol polyethoxylate, Teric N300 which is a monoalcohol. This produced a clear, hard coloured (similar purple cerise colour) coating but with poorer physical properties than was achieved with the polyalcohols. It is thought that these poorer properties are a result of the fact that Teric N300 can not crosslink the film.

All of the other coatings in this series (Experiments 18 to 45) up to and including Experiment 45 produced hard, clear purple cerise coatings with excellent adhesion using the same cure cycle as above.

| | 18 | 19 | 20 | 21 | 22 | 23 | 24 | 25 | 26 | 27 | 28 |
|---|---|---|---|---|---|---|---|---|---|---|---|
| Polyvinylalcohol | 44.5 | 26.7 | 62.2 | | | | | | | | |
| low m. wt., | | | | | | | | | | | |
| 88% hydrolysis | | | | | | | | | | | |
| Sorbitol | 44.5 | 62.2 | 26.7 | 44.5 | 26.7 | 62.2 | | | | | |
| Glycerol | | | | | | | 44.5 | 26.7 | 62.2 | 62.2 | 44.5 |
| Gantrez ® | | | | 44.5 | 62.2 | 26.7 | | | | | |
| AN119 | | | | | | | | | | | |
| Gantrez ® | | | | | | | 44.5 | 62.2 | 26.7 | 26.7 | 44.5 |
| AN139 | | | | | | | | | | | |
| Benzalkonium | 11.1 | 11.1 | 11.1 | 11.1 | 11.1 | 11.1 | 11.1 | 11.1 | 11.1 | 11.1 | |
| chloride: | | | | | | | | | | | |
| Barquat ® MB80 | | | | | | | | | | | |
| Twin chain | | | | | | | | | | | 11.1 |
| quaternary: | | | | | | | | | | | |
| Bardac ® 2280 | | | | | | | | | | | |
| | 29 | 30 | 31 | 32 | 33 | 34 | 35 | 36 | 37 | 38 | 39 |
| Glycerol | 62.2 | 44.5 | 62.2 | 26.7 | | | | | | | |
| Polyethylene | | | | | 44.5 | 26.7 | | | | | |
| glycol 4000 | | | | | | | | | | | |
| Polyethylene | | | | | | | 44.5 | 26.7 | | | |
| glycol 400 | | | | | | | | | | | |
| Teric ® N300 | | | | | | | | | 44.5 | 62.2 | 26.7 |
| Gantrez ® | 26.7 | 44.5 | 26.7 | 62.2 | 44.5 | 62.2 | 44.5 | 62.2 | 44.5 | 26.7 | 62.2 |
| AN139 | | | | | | | | | | | |
| Twin chain | 11.1 | 11.1 | 11.1 | 11.1 | 11.1 | 11.1 | 11.1 | 11.1 | 11.1 | 11.1 | 11.1 |
| quaternary: | | | | | | | | | | | |
| Bardac ® 2280 | | | | | | | | | | | |

| | 40 | 41 | 42 | 43 | 44 | 45 |
|---|---|---|---|---|---|---|
| Glycerol | | | | | | 31.1 |
| Teric ® N30 | | | 44.5 | 26.7 | | |
| Pentaerythritol | 44.5 | 26.7 | | | | |
| Triethanolamine | | | | | 44.5 | |
| Gantrez ® | | | | | 8.9 | |
| AN119 | | | | | | |
| Gantrez ® | 44.5 | 62.2 | 44.5 | 62.2 | 35.5 | 13.3 |
| AN139 | | | | | | |
| Twin chain | 11.1 | 11.1 | 11.1 | 11.1 | | |
| quaternary: | | | | | | |
| Bardac ® 2280 | | | | | | |
| Benzalkonium | | | | | 11.1 | 55.6 |
| chloride: | | | | | | |
| Barquat ® | | | | | | |
| MB80 | | | | | | |

Experiments 46 and 48 (not included in tables) contained only glycerol and Gantrez® AN 139 in the ratio 70:30 and were done in duplicate. These were controls with respect to zone of inhibition and produced none. Air dried coatings and heat cured coatings of these did not produce any zone of inhibition against Staphylococcus aureus. The heat cured coating was not coloured.

Experiments 52, 55 and 58 below also included no quaternary biocide and the film was laid down from an aqueous solution in the case of 52 and 55 and an anhydrous solution of methanol and ethanol in the case of 58. Once again no zone of inhibition was produced in any cases. The same colour was produced by these upon baking.

| | 47 | 49 | 50 | 51 | 52 | 53 | 54 | 55 | 56 | 57 | 58 |
|---|---|---|---|---|---|---|---|---|---|---|---|
| Glycerol | 62.3 | 61.8 | 66.9 | 70.7 | 70.0 | 75.3 | 68.2 | 70.0 | 73.8 | 66.9 | 30.0 |
| Gantrez ® | 26.7 | 26.5 | 23.3 | 20.3 | 30.0 | 17.6 | 23.2 | 30.0 | 18.0 | 23.3 | 70.0 |
| AN139 | | | | | | | | | | | |
| Twin chain | 11.0 | | 9.8 | 9.0 | | | | | 8.2 | 9.8 | |
| quaternary: | | | | | | | | | | | |
| Bardac ® | | | | | | | | | | | |
| 2280 | | | | | | | | | | | |
| Benzalkonium | | | | | | 7.1 | 8.6 | | | | |
| chloride | | | | | | | | | | | |
| Lonza ® JAQ | | | | | | | | | | | |
| Chlorhexidine | | 11.7 | | | | | | | | | |
| gluconate | | | | | | | | | | | |

The composition of Experiment 59 formed a good coating with development of colour after baking at 150° C.

Experiment 60 was performed with Gantrez® S95 rather than the AN series to demonstrate that this hydrolysed version of the AN type would produce the same reaction and colour. It did.

Experiments 61 and 62 had identical formulations except for the identity of the quaternary biocide. The films produced, their colours and the zones of inhibition both before and after baking were the same, one to the other.

Experiment 63 once again did not incorporate a quaternary biocide and was used as a baseline with respect to zone of inhibition. There was no zone produced either before or after baking. The solution was anhydrous. No colour was produced on baking. Experiment 64 was different from the others only in respect to the coating being laid down, from an anhydrous solvent system. The coatings produced before and after baking were much the same as those laid down from aqueous systems of the same concentration. The zones of inhibition were also much the same as was the colour.

Experiment 65, which used maleic anhydride with no polymer, failed to produce is either a hard coating or colour on baking. This confirms the need for a polymeric starting material.

Experiment 66 produced coatings before and after baking which were not quite clear but provided zones of inhibition. The baked coating did not produce the colour observed with the other quaternary biocides.

Experiments 67 and 68 incorporated no alcohol and only contained the polymer and the new quaternary biocide salts. In both cases the unbaked and baked coatings produced good zones of inhibition against Staphylococcus aureus and the same colour

Experiment 69 did not incorporate any biocide and was a control. No zone of inhibition was produced and no colour was produced on baking.

| | 59 | 60 | 61 | 62 | 63 | 64 | 65 | 66 | 67 | 68 | 69 |
|---|---|---|---|---|---|---|---|---|---|---|---|
| Glycerol | 63.4 | 62.2 | 20.3 | 20.3 | 70.0 | 62.9 | 32.0 | 67.1 | | | |
| Gantrez ® | 27.0 | | 56.3 | 56.3 | 30.0 | 27.6 | | 28.7 | 73.9 | 69.4 | 73.5 |
| AN139 | | | | | | | | | | | |
| Gantrez ® S95 | | 26.7 | | | | | | | | | |
| Maleic | | | | | | | 51.0 | | | | |
| anhydride | | | | | | | | | | | |
| Twin chain | | 11.1 | 23.4 | | | | | | | 30.6 | |
| quaternary: | | | | | | | | | | | |
| Bardac ® | | | | | | | | | | | |
| 2280 | | | | | | | | | | | |
| Benzalkonium | 9.6 | | | 23.4 | | 9.5 | 17.0 | | 26.1 | | |
| chloride | | | | | | | | | | | |
| Lonza ® JAQ | | | | | | | | | | | |
| Chlorhexidine | | | | | | | | 4.2 | | | |
| gluconate | | | | | | | | | | | |
| | 70 | 71 | 72 | 73 | 74 | 75 | 76 | 77 | 78 | 79 | 80 |
| Polyvinylalcohol | 22.1 | 22.1 | 22.1 | 27.7 | 27.7 | 27.7 | | | | | |
| low m. wt. | | | | | | | | | | | |
| 88% hydrolysis | | | | | | | | | | | |
| Glycerol | | | | | | | | | | 21.3 | |
| Teric ® N300 | | | | | | | 27.7 | 27.7 | 27.7 | | |
| Triethanolamine | | | | | | | | | | 40.0 | |
| Gantrez ® | 61.1 | 61.1 | 61.1 | | | | | | | 59.0 | |
| AN139 | | | | | | | | | | | |
| Gantrez ® | | | | 54.2 | 54.2 | 54.2 | 54.2 | 54.2 | 54.2 | | 60.0 |
| AN119 | | | | | | | | | | | |
| Maleic | | | | | | | 51.0 | | | | |
| anhydride | | | | | | | | | | | |
| Benzalkonium | | 16.8 | | 18.1 | | | 18.1 | | | | |
| chloride: | | | | | | | | | | | |
| Barquat ® MB80 | | | | | | | | | | | |
| Twin chain | | | 16.8 | | 18.1 | | | 18.1 | | 19.7 | |
| quaternary: | | | | | | | | | | | |
| Bardac ® 2280 | | | | | | | | | | | |
| Benzalkonium | 16.8 | | | | | 18.1 | | | 18.1 | | |
| chloride Lonza ® | | | | | | | | | | | |
| JAQ | | | | | | | | | | | |

Experiments 70 to 79 each produced a zone of inhibition and became coloured following baking, while Experiment 80 produced no zone of inhibition and no colour.

Experiment 81 was performed as a baseline without quaternary biocide and the coating unbaked and baked produced no zones of inhibition.

Experiment 82 produced a definite zone of inhibition and became coloured on baking.

Experiment 83 was performed from an aqueous solution to investigate if the polyamide produced between the diamine and the polycarboxylic acid would produce zones of inhibition unbaked and baked. Zones of inhibition were produced in both cases and the baked coating produced a deep red purple colour.

Experiment 84 was performed from an anhydrous solution to investigate if the polyimide produced between the diamine and the polycarboxylic anhydride would produce zones of inhibition unbaked and baked. Zones of inhibition were produced in both cases and the baked coating produced a deep red colour.

Experiment 85 was performed using a different polyacid. The composition of Carbopol® 940 is strictly proprietary however this polymer is known to consist of acrylic acids and other acrylic monomers. It was used to investigate if quaternary biocide salts of this polymer would react with a polyalcohol and produce a biocidal coating. Coatings produced by this formulation both unbaked and baked produced excellent zones of inhibition against Staphylococcus aureus and it was noted that the baked coating had no colour.

| | 81 | 82 | 83 | 84 | 85 |
|---|---|---|---|---|---|
| Ethanolamine | 40.0 | | | | |
| 1,4-butanediol | | 27.8 | 20.8 | 20.8 | 26.4 |
| Gantrez ® | 60.0 | 54.2 | 51.1 | 51.1 | |
| AN119 | | | | | |
| Carbopol ® 940 | | | | | 51.8 |
| Twin chain | | 18.0 | 21.3 | 21.3 | |
| quaternary: | | | | | |
| Bardac ® 2280 | | | | | |
| Benzalkonium | | | | | 21.8 |
| chloride: | | | | | |
| Barquat ® | | | | | |
| MB80 | | | | | |
| Hexamethylene | | 6.8 | 6.8 | | |
| diamine | | | | | |

Every formulation provided in the above experiments which incorporates a biocidal quaternary ammonium salt provided a zone of inhibition, indicating that these salts retained their biocidal properties when in the experimental compositions. The size of the zones varied.
Examples which Include Epoxy Resins
Some of the formulations below include glycidyl ethers which have been used mainly as reactive diluents to make the epoxy polymer easier to emulsify. Without this step the epoxy polymer must be heated to lower the viscosity sufficiently that emulsification is possible. Even with the reactive diluent warming is preferred.

In the examples below a low molecular weight polyvinylalcohol (PVOH) of approximately 90% hydrolysis was employed but it should be understood that any grade of PVOH or its copolymers could equally be used. Also in these examples the only quaternary ammonium biocide used was benzalkonium chloride, however any other is quaternary ammonium biocide could equally be used. In the examples the only polycarboxylic acid employed was Gantrez® AN119 but any other polycarboxylic acid whether water soluble or emulsifiable could equally be used. The only reactive epoxy diluents used in the examples below were butyl glycidyl ether and phenyl glycidyl ether but any other reactive or unreactive epoxy diluents could equally be used alone or in combination.

The series of formulations below employed a final baking step at least 120° C. Higher temperature curing cycles can be employed for shorter periods. Upon heat curing, each of these formulations develops colour.

The examples listed below are formulations where epoxy has been incorporated into the formulations in order to improve the specific properties of water resistance and corrosion resistance. Should other specific properties be required to be altered, then other polymers or copolymers whether reactive, such as in the case of the epoxies, or unreactive may be incorporated. Examples of such polymers or copolymers are acrylic emulsion polymers, styrene acrylic emulsion polymers, ethylene copolymer emulsions, polyurethane emulsion polymers, polyvinylacetate emulsion polymers, epoxy ester polymer or copolymer emulsions, etc. In the formulations below, “epoxy resin” refers to EPON® Resin 828. This is a difunctional bisphenol A/epichlorohydrin derived liquid epoxy resin.

### Epoxy Formulation 1

| | |
|---|---|
| Water | 85.1% w/w |
| Polyvinylalcohol | 7.1% w/w |
| (low molecular weight, hydrolysis approx. 90%) | |
| Gantrez ® AN119 | 2.5% w/w |
| Barquat ® MB80 | 3.2% w/w |
| Epoxy Resin | 1.8% w/w |
| Teric ® N30 | 0.2% w/w |
| Teric ® N12 | 0.1% w/w |

### Epoxy Formulation 2

| | |
|---|---|
| Water | 85.5% w/w |
| Polyvinylalcohol | 7.1% w/w |
| (low molecular weight, hydrolysis approx. 90%) | |
| Gantrez ® AN119 | 3.2% w/w |
| Barquat ® MB80 | 3.0% w/w |
| Epoxy Resin | 1.0% w/w |
| Teric ® N30 | 0.15% w/w |
| Teric ® N12 | 0.05% w/w |

### Epoxy Formulation 3

| | |
|---|---|
| Water | 82.3% w/w |
| Polyvinylalcohol | 8.0% w/w |
| (low molecular weight, hydrolysis approx. 90%) | |
| Gantrez ® AN119 | 2.8% w/w |
| Barquat ® MB80 | 3.2% w/w |
| Epoxy Resin | 2.0% w/w |
| Butyl glycidyl ether | 1.5% w/w |
| Teric ® N30 | 0.10% w/w |
| Teric ® N12 | 0.05% w/w |
| Teric ® N5 | 0.05% w/w |

### Epoxy Formulation 4

| | |
|---|---|
| Water | 80.8% w/w |
| Polyvinylalcohol | 7.1% w/w |
| (low molecular weight, hydrolysis approx. 90%) | |
| Gantrez ® AN119 | 2.2% w/w |
| Barquat ® MB80 | 6.2% w/w |
| Epoxy Resin | 2.0% w/w |
| Phenyl glycidyl ether | 1.5% w/w |
| Teric ® N30 | 0.10% w/w |
| Teric ® N12 | 0.05% w/w |
| Teric ® N5 | 0.05% w/w |

### Epoxy Formulation 5

| | |
|---|---|
| Water | 80.6% w/w |
| Polyvinylalcohol | 7.1% w/w |
| (low molecular weight, hydrolysis approx. 90%) | |
| Gantrez ® AN119 | 2.2% w/w |
| Barquat ® MB80 | 6.2% w/w |
| Epoxy Resin | 2.2% w/w |
| Phenyl glycidyl ether | 0.75% w/w |
| Butyl glycidyl ether | 0.75% w/w |
| Teric ® N30 | 0.10% w/w |
| Teric ® N12 | 0.05% w/w |
| Teric ® N5 | 0.05% w/w |

All of the example formulations described above which incorporated biocidal quaternary ammonium molecules produced coated substrates which were, after drying and also after baking, resistant to microbial colonization.

### Testing

Aluminium air conditioned fin stock test panels were cleaned with ethanol and allowed to dry. They were then dipped in solution defined below with excess solution being allowed to drain for 2 minutes. They were then allowed to air dry until tack free and baked at 150° C. for 20-40 minutes.

### Treating Solution

| | | |
|---|---|---|
| Polymer | 11% | poly(vinylmethyl ether-co-maleic anhydride) |
| Glycol | 3% | |
| Biocide | 3% | didecyldimethylammonium chloride |
| Water | balance to 100% | |

### 1) Alkali Resistance

A test panel prepared as described above were immersed in 0.1N aqueous NaOH solution at 20° C. for 30 minutes

Results: no effervescence was observed on alkali immersion. After rinsing, no change to the surface of the test panel could be observed by visual inspection.

### 2) Moisture Resistance

A test panel prepared as described above were exposed to 98% humidity at 50° C. for 500 hours.
Results: no unevenness or discontinuities were observed by visual inspection.

### 3) Abrasion Resistance

A test panel prepared as described above were placed on a flat horizontal surface. A cotton cloth was placed on the panel and a 1 kg weight placed on the cloth. The weight was moved back and forth for 100 cycles.
Results: no change was observed to the surface of the panel by visual inspection.

### 4) Acid Resistance

A test panel prepared as described above was immersed in 1N phosphoric acid at 20° C. for 1 hour.
Results: no effervescence was observed. After rinsing, no change to the surface of the test panel could be observed by visual inspection.

### 5) Adhesion

A test panel prepared as described above was tested using a modified JISK 5600-5-6: 1999 adhesion test (cross-cut test). Two sets of 11 scratches with 2 mm spacings were made in the coating perpendicular to each other. This formed 100 squares of 2 mm×2 mm. Adhesive tape was applied to these squares and then removed.
Results: there was no significant amount of the coating removed onto the adhesive tape.

### 6) Flexibility

A test panel prepared as described above was bent over a 3 mm diameter mandrel through an angle of 180°. An adhesive tape was applied to the length of the bend and then removed.
Results: there was no significant amount of the coating removed onto the adhesive tape. The bent film did not display discontinuities on visual inspection.

### 7) Oil Resistance

Two test panels prepared as described above were immersed in light aliphatic hydrocarbon oil for 24 hours at 20° C.
Results: no wrinkling, cracking or other discontinuities was observed on visual is inspection.

### 8) Heat Resistance

A test panel, prepared as described above, was heated in an over at 200° C. for 5 minutes. In a second test, the panel was heated at 400° C. for 5 minutes.
Results: at 200° C. no significant colour change was observed on visual inspection. At 400° C. no darkening beyond a shade of brown was observed on visual inspection.

### 9) Water Immersion Resistance

A test panel, prepared as described above, was immersed in distilled water for 21 days at 50° C.
Results: no cracks, peeling or other discontinuities were observed on visual inspection. It should be noted that this test is estimated to represent an accelerated test for water susceptibility of the film over its full working life.

### 10) Salt Exposure

A 5% w/w sodium chloride solution was adjusted to pH 6.5-7.5. The fins coated with the solution as described above were baked at 170° C. for 10 minutes and allowed to cool. The resulting films were a gold/brown colour. The coated fins were then immersed in the sodium chloride solution at 45° C. and observed weekly. This is a modification of the Japanese Automotive Cyclic Corrosion Test (CCT-1) recommended by Japanese Automotive manufacturers.

Results: after 3000 hours, the only change observable on visual observation was a slight decrease in film gloss. No discontinuities in the film surface were observed. It should be noted that this test is considered to be equivalent to 6000 hours at 35° C. and indicates an excellent degree of corrosion protection to the aluminium substrate.

### 11) Bactericidal Properties

Aluminium air conditioned fin stock test panels were dipped in solution defined earlier to with excess solution being allowed to drain for 2 minutes. They were then allowed to air dry for 30 minutes and baked at 170° C. for 15 minutes. They were then boiled for 8 hours in water and cooled (this is estimated to equate to normal usage on automotive cooling coils for 10 years). After removal of the coated substrates from the boiling water and cooling, sections of the coated substrate were rinsed in running water to remove any surface biocide and were cut from the cured panels to squares of approximately 10×10 mm. These were the substrates used in the tests below.
i. The standard “Zone of Inhibition” test was performed in duplicate using Tryptone soya agar (TSA) gel poured into a petri dish, which was inoculated with S. aureus (NCTC 4163). After inoculation the cured coupon with the test coating on aluminium fin stock was placed onto the inoculated agar. A lid was placed on the petri dish and put into an incubator set at 37° C.
ii. The standard “Zone of Inhibition” test was performed in duplicate using Tryptone soya agar (TSA) gel poured into a petri dish, which was inoculated with Ps. aeruginosa (ATCC 15442). After inoculation the cured coupon with the test coating on aluminium fin stock was placed onto the inoculated agar. A lid was placed on the petri dish and put into an incubator set at 37° C.
   For i. and ii above the petri dishes were removed from the incubator after 48 hours at 37° C. and observed for a Zone of Inhibition and resistance to overgrowth and undergrowth.
   Results: Staph Aureus (NCTC 4163): for this organism a substantial Zone of Inhibition of at least 1 to 2 mm was observed for each of the duplicates. It was noted there was no undergrowth or overgrowth in either petri dish. Pseudomonas aeruginosa (ATCC 5442): for this organism an insignificant Zone of Inhibition was observed for each of the duplicates. It was noted there was no undergrowth or overgrowth in either petri dish.
   The above testing demonstrates that the cured, boiled coated substrates utilised exhibits bacteriostatic properties against Pseudomonas aeruginosa, a ubiquitous gram negative bacteria known to be resistant to biocides and therefore required by most regulators in demonstrating the activity of biocides. The testing also demonstrates bactericidal activity against Staph aureus, a ubiquitous gram positive bacteria known to be responsible for many infections and commonly used in biocidal activity testing. The above results are indicative of broad spectrum bacteriostatic activity for the cured; boiled Evoguard OEM coating indicating a high probability of ongoing activity after 10 years of exposure in an automotive air conditioning heat exchange coil.

1-40. (canceled)

41. A biocidal composition comprising a carboxyl functional polymer and biocidal quaternary ammonium ions, said polymer being a copolymer comprising maleic acid monomer units or anions thereof, or a combination thereof, and vinyl ether comonomer units;
wherein the polymer is ionized and the quaternary ammonium ions are counterions of the polymer; and
wherein the biocidal quaternary ammonium ions comprise alkyl benzyl dimethylammonium ions or dialkyl dimethylammonium ions, or a combination thereof,
wherein at least one alkyl group of the biocidal quaternary ammonium ions is C10 to C20 alkyl; and
said composition being substantially free of organic solvents.

42. The biocidal composition of claim 41 wherein the polymer comprises a maleic acid-co-alkyl vinyl ether copolymer or a maleate-co-alkyl vinyl ether copolymer.

43. The biocidal composition of claim 41 which is a solution comprising said polymer and quaternary ammonium ions.

44. The biocidal composition of claim 41 wherein said composition is in the form of a film on a surface.

45. The biocidal composition of claim 44 comprising less than about 10% by weight of water.

46. A process for making a biocidal composition, said process comprising the step of combining a polymer, a biocidal quaternary ammonium salt and an aqueous liquid in the absence of an organic solvent so as to form a solution being substantially free of organic solvent, said polymer being a copolymer comprising:
one or more maleic acid groups, maleate groups or maleic anhydride groups, or a combination thereof; and
vinyl ether comonomer units;
wherein the quaternary ammonium salt is present at about 5 to about 100% by weight of the polymer, and wherein the biocidal quaternary ammonium salt comprises an alkyl benzyl dimethylammonium salt or a dialkyl dimethylammonium salt, or a combination thereof, wherein at least one alkyl group of the biocidal quaternary ammonium salt is C10 to C20 alkyl.

47. A composition according to claim 44, said composition being substantially insoluble in water or being slow to dissolve in water, and wherein the composition is capable of performing as a biocidal surface coating.

48. The composition of claim 47 further comprising crosslinking units derived from a crosslinker comprising at least two functional groups, each being independently selected from the group consisting of epoxy, hydroxyl, thiol and amine.

49. The composition of claim 47 having no added pigment and being colored.

50. The composition of claim 47 having a Shore D hardness of at least about 80.

51. A process for making a composition according to claim 47, said process comprising the steps of preparing a first composition and heating said first composition at a sufficient temperature so as to form the substantially water insoluble or slow to dissolve in water coating; said first composition comprising a carboxyl functional polymer and biocidal quaternary ammonium ions; said polymer being a copolymer comprising maleic acid monomer units or anions thereof, or a combination thereof, and vinyl ether comonomer units; and said first composition being in the form of a film on a surface;
wherein the biocidal quaternary ammonium ions comprise alkyl benzyl dimethylammonium ions or dialkyl dimethylammonium ions, or a combination thereof, wherein at least one alkyl group of the biocidal quaternary ammonium ions is C10 to C20 alkyl.

52. The process of claim 51 wherein said film is substantially tack free prior to the heating.

53. The process of claim 51 wherein said first composition further comprises a crosslinker.

54. The process of claim 51 comprising the steps of:
combining a polymer, a biocidal quaternary ammonium salt and an aqueous liquid so as to form a solution, wherein the biocidal quaternary ammonium salt comprises an alkyl benzyl dimethylammonium salt or a dialkyl dimethylammonium salt, or a combination thereof, wherein at least one alkyl group of the biocidal quaternary ammonium salt is C10 to C20 alkyl;
applying said solution to the surface; and
allowing the aqueous solvent to at least partially evaporate so as to form the film on the surface;
said polymer being a copolymer comprising:
one or more maleic acid groups, maleate groups or maleic anhydride groups, or a combination thereof; and
vinyl ether comonomer units.

55. The process of claim 51 wherein the heating is continued until the film has a red or purple or gold or brown color.

56. The process of claim 51 wherein the first composition further comprises a crosslinker comprising at least two functional groups, each being independently selected from the group consisting of epoxy, hydroxyl, thiol and amine.

57. A method for disinfecting a surface comprising applying to said surface a composition according to claim 43.

58. A method for inhibiting biofilm growth on a surface, said method comprising forming a composition on said surface using the process of claim 51.

59. The method of claim 58 wherein said surface is a surface of a component of an air conditioning unit or an internal surface of a refrigerator or of a freezer.

60. The method of claim 59 wherein said air conditioning unit is a car air conditioner.
